(19) United States
(12) Patent Application Publication
(10) Pub. No.: US 2006/0217469 A1
(43) Pub. Date: Sep. 28, 2006

(54) Use of stabilizers in phosphorus-containing thermally stabilized flame retardant agglomerates

(75) Inventors: Harald Bauer, Kerpen (DE); Sebastian Hoerold, Diedorf (DE); Werner Krause, Huerth (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT Produkte (Deutschland) GmbH

(21) Appl. No.: 11/388,329

(22) Filed: Mar. 24, 2006

(30) Foreign Application Priority Data
Mar. 26, 2005 (DE) 10 2005 013958.2

(51) Int. Cl. C08K 5/49

(52) U.S. Cl. 524/115

(57) ABSTRACT

The invention relates to the use of stabilizers in phosphorus-containing thermally stabilized flame retardant agglomerates.

The present invention is described in the German priority application No. 102005013958.2, filed 26 Mar. 2005, which is hereby incorporated by reference as is fully disclosed herein.

The invention relates to the use of stabilizers in phosphorus-containing thermally stabilized flame retardant agglomerates to counteract their discoloration on heating. Said phosphorus-containing thermally stabilized flame retardant agglomerates comprise aggregates and/or primary particles composed of phosphinic salts and/or of diphosphinic salts, and/or of polymers thereof, and cohere with the aid of a binder. The invention also relates to a process for preparation of these phosphorus-containing thermally stabilized flame retardant agglomerates, and to the use of the same as flame retardants in polymers.

The prior art succeeds in preparing phosphorus-containing flame retardants via spray agglomeration (DE-A-103 47 012). Binders are used here which are intended to stabilize the agglomerate mechanically.

The agglomerates described in the prior art are disadvantageous because they discolor on heating. Since this heating takes place during correct processing of the agglomerates to give flame-retardant molding compositions or to give flame-retardant moldings, disadvantageous discoloration also occurs in these products.

It is an object of the present invention to provide phosphorus-containing thermally stabilized flame retardant agglomerates which comprise binders and which are substantially more resistant to discoloration on heating.

This object is achieved via the use of stabilizers in the phosphorus-containing thermally stabilized flame retardant agglomerates.

Surprisingly, it has been found that the otherwise usual discoloration of the phosphorus-containing thermally stabilized flame retardant agglomerates on heating can be substantially prevented.

The invention therefore provides the use of stabilizers in phosphorus-containing thermally stabilized flame retardant agglomerates.

It is preferable that the stabilizers are compounds of the elements of the second main and transition group and of the third main group of the periodic table of the elements.

It is preferable that the stabilizers are compounds of the elements boron, calcium, magnesium, and/or zinc.

It is preferable that the stabilizers are boron phosphate.

It is preferable that the stabilizers are calcium borate, calcium pyroborate, calcium carbonate, calcium hydroxide, calcium phosphates, calcium hydrogenphosphates, and/or calcium pyrophosphate.

It is preferable that the stabilizers are magnesium oxide, magnesium hydroxide, magnesium oxide hydroxides, hydrotalcites, dihydrotalcite, magnesium carbonates, magnesium hydroxide carbonates, magnesium calcium carbonates, magnesium phosphates, magnesium hydrogenphosphates, magnesium pyrophosphate, and/or magnesium borate.

It is preferable that the stabilizers are zinc oxide, zinc hydroxide, zinc oxide hydrate; zinc carbonates, zinc hydroxide carbonate, zinc carbonate hydrate, zinc silicate, zinc hexafluorosilicate, zinc hexafluorosilicate hexahydrate, zinc stannate, zinc magnesium aluminum hydroxide carbonate; zinc borate, zinc phosphate, zinc hydrogenphosphate, zinc pyrophosphate; zinc chromate(VI) hydroxide, zinc chromite, zinc molybdate, zinc permanganate, zinc molybdate magnesium silicate; zinc formates, zinc acetates, zinc trifluoroacetates, zinc propionate, zinc butyrate, zinc valerate, zinc caprylate, zinc oleate, zinc stearate, zinc oxalate, zinc tartrate, zinc citrate, zinc nenzoate, zinc salicylate, zinc lactate, zinc phenolate, zinc phenolsulfonate, zinc acetylacetonate, zinc tannate, zinc dimethyldithiocarbamate, zinc trifluoromethanesulfonate; zinc phosphides, zinc sulfides, zinc selenides, and zinc tellurides.

It is particularly preferable that the stabilizers are boron phosphate, calcium pyrophosphate, magnesium pyrophosphate, magnesium borate, zinc oxide, zinc hydroxide, zinc borate, zinc stearate, and/or zinc pyrophosphate.

It is preferable that the phosphorus-containing thermally stabilized flame retardant agglomerates are compositions which comprise
a) from 60 to 99.89% by weight of aggregates and/or primary particles composed of a phosphinic salt of the formula (I) and/or composed of a diphosphinic salt of the formula (II), and/or composed of polymers thereof, 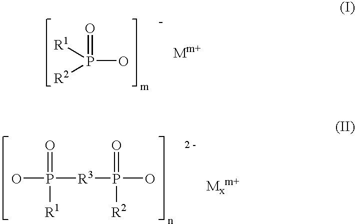
in which
R¹ and R² are identical or different and are C1-C6-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Zn, Sb, Sn, Ge, Zn, Ti, Fe, Zr, Ce, Bi, Sr, Mn, Li, Na, K, and/or a protonated nitrogen base;
m is from 1 to 4; n is from 1 to 4; x is from 1 to 4, and
   b) from 0.01 to 20% by weight of binder,
   c) from 0.1 to 20% by weight of stabilizer of claims 3 to 8.

It is particularly preferable that the phosphorus-containing thermally stabilized flame retardant agglomerates are compositions which comprise

a) from 60 to 99.89% by weight of aggregates and/or primary particles composed of a phosphinic salt of the formula (I) and/or composed of a diphosphinic salt of the formula (II), and/or composed of polymers thereof, and at least one synergist, and

b) from 0.01 to 20% by weight of binder,

c) from 1 to 20% of stabilizer.

It is preferable that the L color values of the phosphorus-containing thermally stabilized flame retardant agglomerates after heat treatment are from 81 to 99.9, preferably from 85 to 98.

It is preferable that the a color values of the phosphorus-containing thermally stabilized flame retardant agglomerates are from −2 to +2, preferably from −1 to +1.5.

It is preferable that the b color values of the phosphorus-containing thermally stabilized flame retardant agglomerates are from −2 to +8, preferably from −1 to +7.

In the inventive use, the phosphorus-containing thermally stabilized flame retardant agglomerates also comprise at least one synergist in which a nitrogen compound, a phosphorus compound, or a phosphorus-nitrogen compound is present.

It is preferable that the synergist is melamine pyrophosphate, melamine polyphosphate, melam polyphosphate, melem polyphosphate, melon polyphosphate, melamine cyanurate, melamine, melam, melem and/or melon.

It is preferable that the binder is homopolymers or mixed polymers based on at least one monomer from the group of 1,2-butadiene, 1,3-butadiene, 2-ethylhexyl acrylate, degraded starch, acrolein, acrylamide, acrylamidomethylpropanephosphonic acid, hydroxyethyl(meth)acrylate sulfates, acrylamidomethylpropanesulfonic acid, acrylic ester, acrylonitrile, acrylic acid, aldehyde starches, alkylcellulose, alkylhydroxyethylcellulose, and alkyl is preferably methyl, allyl alcohol phosphates, allyl alcohol sulfates, allylacetic acid, allylphosphonic acid, amides, aspartic acid, caprolactam, carboxyalkylcellulose (Na-salt), crotonic acid, di- or oligosaccharides, dibutyl maleate, dimethylacrylic acid, epoxides, esters, ethyl acrylate, ethylacrylic acid, ethylene, ethylene glycol, ethylhexyl acrylate, ethyl methacrylate, fumaric acid, hydroxyacrylic acid, hydroxyethylcellulose, hydroxypropylcellulose, isobutyl acrylate, isobutyl methacrylate, itaconic acid, lauryl acrylate, maleic acid, maleic anhydride, methallylsulfonic acid, methacrylamide, methacrylate, methacrylonitrile, methacrylic acid, methyl methacrylate, methylstyrene, lactic acid, monosodium carboxymethylcellulose, n-butyl acrylate, n-butyl methacrylate, n-hexyl acrylate, n-hexyl methacrylate, N-hydroxymethyl acrylamide, n-propylacrylate, N-vinylpyrrolidone, olefins, polyvinyl butyral, polyvinylcaprolactam, propylene, sec-butyl acrylate, stearates, styrene, styrenesulfonic acid, tert-butyl acrylate, tert-butyl chloride, tert-butyl methacrylate, urethanes, vinyl acetate, vinyl alcohol derivatives, vinylcaprolactam, vinyl chloride, vinylacetic acid, vinyl esters, vinyl ethers, vinylidene chloride, vinyl laurate, vinyl methyl ethers, vinylphosphonic acid, vinyl propionate, vinylpyrrolidone, vinylsulfonic acid, sugar carboxylic acid, and/or a mixture thereof.

It is preferable that the binder is polyvinyl acetate, polyvinyl alcohol, polyvinylpyrrolidone, polycarboxylate, acrylic acid-maleic acid copolymer, polystyrenesulfonic acid, polystyrenesulfonic acid-maleic anhydride copolymer, water glass, vinyl acetate polymer, polyacrylate/polyacrylic acid, polylactic acid, starch, and/or cellulose derivatives.

The invention also provides the use of stabilizer-containing phosphorus-containing flame retardant agglomerates as claimed in one or more of claims 9 to 15 in flame-retardant polymer molding compositions and in flame-retardant polymer moldings, flame-retardant polymer films, flame-retardant polymer filaments, and flame-retardant polymer fibers.

The flame-retardant polymer molding composition here preferably comprises

from 1 to 50% by weight of phosphorus-containing thermally stabilized flame retardant agglomerates as claimed in one or more of claims 9 to 15,

from 1 to 99% by weight of polymer or a mixture of these,

from 0 to 60% by weight of additives,

from 0 to 60% by weight of filler and/or of reinforcing materials.

It is preferable that the flame-retardant polymer moldings, flame-retardant polymer films, flame-retardant polymer filaments, and flame-retardant polymer fibers comprise

from 1 to 50% by weight of phosphorus-containing thermally stabilized flame retardant agglomerates as claimed in one or more of claims 9 to 15,

from 1 to 99% by weight of polymer or a mixture of these,

from 0 to 60% by weight of additives,

from 0 to 60% by weight of filler and/or of reinforcing materials.

According to the invention, the expression “phosphorus-containing thermally stabilized flame retardant agglomerates” means particles of a phosphorus-containing thermally stabilized flame retardant composition which are composed of primary particles and/or of aggregates of a phosphinic salt of the formula (I), and/or of a diphosphinic salt of the formula (II), and/or of polymers thereof, and which comprise a stabilizer, and which have been bound to one another via a binder.

It is preferable that the phosphorus-containing thermally stabilized flame retardant agglomerates also comprise

a) from 98.9 to 85% by weight of aggregates and/or primary particles composed of a phosphinic salt of the formula (I) and/or composed of a diphosphinic salt of the formula (II), and/or composed of polymers thereof, and

b) from 0.1 to 5% by weight of binder, and

c) from 1 to 10% by weight of stabilizer.

It is preferable that the last-mentioned phosphorus-containing thermally stabilized flame retardant agglomerates comprise

a) from 98.9 to 85% by weight of aggregates and/or primary particles composed of a phosphinic salt of the formula (I) and/or composed of a diphosphinic salt of the formula (II), and/or composed of polymers thereof, and at least one synergist, and

b) from 0.1 to 5% by weight of binder, and

c) from 1 to 10% by weight of stabilizer.

It is preferable that the average particle size of the phosphorus-containing thermally stabilized flame retardant agglomerates is from 0.1 to 3000 μm, preferably from 100 to 3000 μm, and particularly preferably from 200 to 2000 μm. Smaller particle sizes do not provide freedom from dust. Larger particle sizes give products with increased abrasion values and very low bulk density.

It is preferable that the bulk density of the phosphorus-containing thermally stabilized flame retardant agglomerates is from 80 to 1500 g/l, preferably from 80 to 800 g/l, particularly preferably from 200 to 600 g/l. Lower bulk densities make it more difficult to incorporate the material into the polymer, using the extruder to give flame-retardant polymer molding compositions, because of high air content. Higher bulk densities are impossible or difficult to prepare via agglomeration.

It is preferable that the residual moisture content of the phosphinate aggregates or synergist aggregates used is from 0.05 to 30% by weight, preferably from 0.1 to 5% by weight. Phosphinate aggregates or synergist aggregates with higher residual moisture contents become impossible to handle because they tend to clump. Phosphinate aggregates or synergist aggregates with lower residual moisture contents are difficult to prepare industrially.

It is preferable that the average particle diameter of the phosphinate aggregates or synergist aggregates used is from 0.1 to 500 μm, preferably from 1 to 100 μm.

Phosphinate aggregates or synergist aggregates with larger average particle diameter give inhomogeneity in the flame-retardant polymer moldings. Phosphinate aggregates or synergistic aggregates with lower average particle diameter are difficult to prepare industrially.

The inventive phosphinate aggregates or inventive synergist aggregates are composed of phosphinate primary particles and, respectively, of synergist primary particles.

It is preferable that the average particle diameter of the phosphinate primary particles or synergist primary particles is from 0.1 to 50 μm, preferably from 1 to 10 μm.

The color values are stated in the Hunter system (CIE-LAB system, Commission Internationale d'Eclairage). L color values are from 0 (black) to 100 (white), a color values are from −a (green) to +a (red), and b color values are from −b (blue) to +b (yellow).

Phosphorus-containing thermally stabilized flame retardant agglomerates with L color values below the inventive range (see examples) require greater use of white pigment. Diorganylphosphinic salts whose a or b color values are outside the inventive range require greater use of white pigments. This impairs the mechanical stability properties of the polymer molding (e.g. modulus of elasticity, notched impact resistance, tensile strain at break, and/or tensile strength).

It is preferable that the abrasion value for the phosphorus-containing thermally stabilized flame retardant agglomerates is from 30 to 95%, particularly from 40 to 80%. Phosphorus-containing thermally stabilized flame retardant agglomerates with higher abrasion values do not meet the low-dust requirement, and those with lower abrasion values give inhomogeneity in the flame-retardant polymer moldings.

It is preferable that the residual moisture content of the phosphorus-containing thermally stabilized flame retardant agglomerates is from 0.05 to 2% by weight, particularly from 0.1 to 1% by weight. Residual moisture contents outside the inventively preferred range impair compatibility with polymer. This means poorer strength values and elasticity values for the flame-retardant polymer molding compositions and for the flame-retardant polymer moldings.

According to the invention, the expression phosphorus-containing thermally stabilized flame retardant agglomerates also includes particles of a phosphorus-containing stabilized flame retardant composition which are composed of primary particles and/or of aggregates/primary particles of a phosphinic salt of the formula (I) and/or of a diphosphinic salt of the formula (II), and/or of polymers thereof, and of at least one synergist, and which have been bound to one another via a binder.

Component a) preferably comprises from 10 to 95% by weight of phosphinic salt of the formula (I) and/or diphosphinic salt of the formula (II), and/or polymers thereof, and from 95 to 10% by weight of at least one synergist.

It is preferable that component a) comprises from 25 to 75% by weight of phosphinic salt of the formula (I) and/or diphosphinic salt of the formula (II), and/or polymers thereof, and from 25 to 75% by weight of at least one synergist.

In one preferred embodiment, component a) comprises from 10 to 90% by weight of a zinc and/or aluminum and/or titanium and/or zirconium and/or iron salt of phosphinic acid of the formula (I), and/or of diphosphinic acid of the formula (II), and/or polymers thereof, and from 10 to 90% by weight of at least one synergist selected from at least one member of the group of the

b) salts of phosphoric acid with melamine and of the materials obtainable from these via heat treatment, and/or

c) salts of phosphoric acid with condensates of melamine and of the materials obtainable from these via heat treatment, and/or

d) salts of phosphoric acid with hydrolysis products of melamine and of the materials obtainable from these via heat treatment, and/or

e) salts of melamine with the condensates of phosphoric acid and of the materials obtainable from these via heat treatment, and/or

f) salts of condensates of melamine with condensates of phosphoric acid, and of the materials obtainable from these via heat treatment, and/or

g) salts of hydrolysis products of melamine with condensates of phosphoric acid, and of the materials obtainable from these via heat treatment.

In another embodiment, component a) comprises from 30 to 80% by weight of a zinc and/or aluminum and/or titanium and/or zirconium and/or iron salt of phosphinic acid of the formula (I) and/or of diphosphinic acid of the formula (II), and/or polymers thereof, and from 20 to 70% by weight of at least one synergist selected from at least one member of the group of the

b) salts of phosphoric acid with melamine and of the materials obtainable from these via heat treatment, and/or

c) salts of phosphoric acid with condensates of melamine and of the materials obtainable from these via heat treatment, and/or

d) salts of phosphoric acid with hydrolysis products of melamine and of the materials obtainable from these via heat treatment, and/or

e) salts of melamine with the condensates of phosphoric acid and of the materials obtainable from these via heat treatment, and/or

f) salts of condensates of melamine with condensates of phosphoric acid, and of the materials obtainable from these via heat treatment, and/or

g) salts of hydrolysis products of melamine with condensates of phosphoric acid, and of the materials obtainable from these via heat treatment, and

from 1 to 50% by weight of at least one stabilizer (in particular boron phosphate, calcium pyrophosphate, magnesium pyrophosphate, magnesium borate, zinc oxide, zinc hydroxide, zinc borate, zinc stearate and/or zinc pyrophosphate).

It is preferable that M in the formulae (I) and (II) is calcium, aluminum, titanium, or zinc.

Protonated nitrogen bases are preferably the protonated bases of ammonia, melamine, triethanolamine, in particular NH⁴⁺.

It is preferable that R¹ and R², identical or different, are C₁-C₆-alkyl, linear or branched, and/or phenyl.

It is particularly preferable that R¹ and R², identical or different, are methyl, ethyl, n-propyl, isopropyl, n-butyl, tert-butyl, n-pentyl, and/or phenyl.

It is preferable that R³ is methylene, ethylene, n-propylene, isopropylene, n-butylene, tert-butylene, n-pentylene, n-octylene, or n-dodecylene; phenylene or naphthylene; methylphenylene, ethylphenylene, tert-butylphenylene, methylnaphthylene, ethylnaphthylene, or tert-butylnaphthylene; phenylmethylene, phenylethylene, phenylpropylene, or phenylbutylene.

Synergists

The synergist is preferably a synergist in which a nitrogen compound, phosphorus compound, or phosphorus-nitrogen compound is present.

Suitable synergists are melamine phosphate (e.g. ®Melapur MPH, ®Melapur MP from Ciba-DSM Melapur), melamine acetate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate (e.g. ®Budit 311 from Budenheim, ®MPP-B from Sanwa Chemicals), melamine polyphosphates, melam polyphosphates, melem polyphosphates, and/or melon polyphosphates. Particular preference is given to melamine polyphosphates such as ®Melapur 200/70, ®Melapur CGX FR231 from Ciba-DSM Melapur, ®Budit 3141, 3141 CA and 3141 CB, and melamine polyphosphate/melamine pyrophosphate of grades 13-1100, 13-1105, 13-1115, MPP02-244 from Hummel Croton, and PMP-100(R), or PMP-200 from Nissan Chemical Industries, Japan. Other suitable products are: ®Melapur MC 25, ®Melapur MC, or ®Melapur MC XL from Ciba-DSM Melapur, and melamine ammonium polyphosphates.

In another embodiment, it is preferable that inventive melamine polyphosphates are condensates of melamine or reaction products of melamine with phosphoric acid, or reaction products of condensates of melamine with phosphoric acid, or else mixtures of the products mentioned. Examples of condensates of melamine are melem, melam, or melon, or higher-condensation-level compounds of this type, and also mixtures of the same.

Reaction products with phosphoric acid are compounds produced via reaction of melamine or of the condensed melamine compounds, such as melam, melem, or melon, etc., with phosphoric acid.

Examples of these are melamine polyphosphate, melam polyphosphate (PMP-200™ from Nissan Chemical Industries), and melem polyphosphate (PMP-300™ from Nissan Chemical Industries), or mixed polysalts. The compounds mentioned have been disclosed previously in the literature and can also be prepared via processes other than direct reaction with phosphoric acid. By way of example, melamine polyphosphate can be prepared via reaction of polyphosphoric acid and melamine, or via condensation of melamine phosphate and, respectively, melamine pyrophosphate.

In another embodiment, it is preferable that inventive melamine polyphosphates are products obtained via thermal post-treatment of reaction products of melamine and/or of condensates of melamine with phosphoric acid.

According to the invention, synergists to which further preference is given are oligomeric esters of tris(hydroxyethyl)isocyanurate with aromatic polycarboxylic acids, benzoguanamine, tris(hydroxyethyl)isocyanurate, melamine condensates, such as melam, melem, and/or melon, melamine cyanurate (e.g. ®Melapur MC or ®Melapur MC XL from Ciba-DSM Melapur), dicyandiamide, and/or guanidine.

According to the invention, synergists to which further preference is given are nitrogen-containing phosphates of the formulae (NH₄)yH₃-yPO₄ or (NH₄PO₃)z, where y is from 1 to 3, and z is from 1 to 10 000.

According to the invention, preferred synergists are nitrogen compounds such as allantoin, melamine, cyanuric acid, glycoluril, urea, and their derivatives, e.g. those of the formulae (III) to (VIII), or a mixture thereof 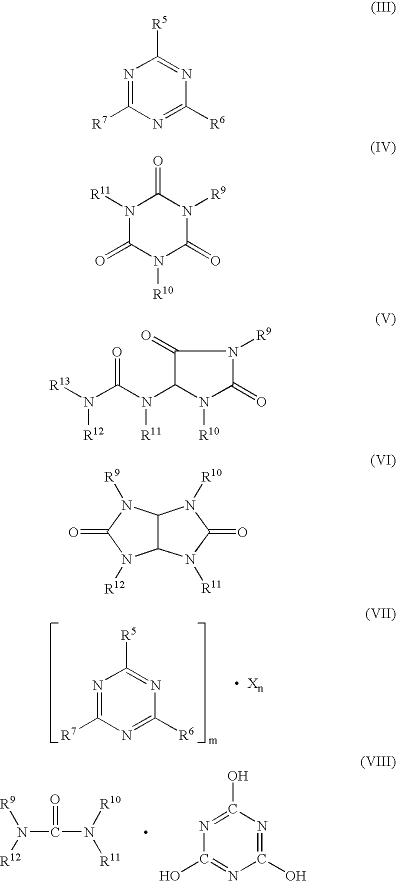
where
R⁵ to R⁷ are hydrogen, C₁-C₈-alkyl, C₅-C₁₆-cycloalkyl or -alkylcycloalkyl, where appropriate substituted with a hydroxy function or with a C₁-C₄-hydroxyalkyl function, C₂-C₈-alkenyl, C₁-C₈-alkoxy, -acyl, -acyloxy, C₆-C₁₂-aryl or -arylalkyl, —OR⁸, and —N(R⁸)R⁹, including systems of N-alicyclic or N-aromatic type,
R⁸ is hydrogen, C₁-C₈-alkyl, C₅-C₁₆-cycloalkyl or -alkylcycloalkyl, where appropriate substituted with a hydroxy function or with a C₁-C₄-hydroxyalkyl function, C₂-C₈-alkenyl, C₁-C₈-alkoxy, -acyl, -acyloxy, or C₆-C₁₂-aryl or -arylalkyl,
R⁹ to R¹³ are groups identical with R⁸ or else —O—R⁸,
m and n, independently of one another, are 1, 2, 3, or 4, and
x is acids which can form adducts with triazine compounds (III).

Compounds of elements of the third main group, particularly preferably of aluminum, are preferred synergists.

Aluminum compounds such as aluminum oxide, aluminum oxide hydroxide (boehmite, diaspore), aluminum hydroxide (bayerite, gibbsite, hydrargillite) or aluminum phosphate are preferred synergists.

Tin compounds such as tin oxide, tin oxide hydrates, stannous hydroxide, tin sulfide are preferred synergists.

Other preferred synergists are carbodiimides (e.g. ®Stabaxol 1, ®Stabaxol P, Stabaxol KE 9193 from Rhein Chemie), N,N′-dicyclohexylcarbodiimide, and/or polyisocyanates (e.g. ®Basonat HI 100 or ®Vestanat T 1890/100), carbonylbiscaprolactam (Allinco), or styrene-acrylic polymers (®Joncryl ADR-4357 from Johnson); sterically hindered phenols (e.g. ®Hostanox OSP 1), sterically hindered amines and light stabilizers (e.g. ®Chimasorb 944, ®Hostavin grades), phosphonites and antioxidants (e.g. Sandostab® P-EPQ from Clariant), and release agents (®Licomont grades from Clariant).

Compounds of the elements of the second main and transition group and of the third main group are preferred stabilizers, and particular preference is given to compounds of the elements boron, calcium, magnesium, and zinc.

Boron compounds such as boron phosphate (Budit 1304, Budenheim) are preferred stabilizers.

Among the magnesium compounds, preferred stabilizers are magnesium oxide magnesium hydroxide (e.g. ®Magnifin H5 from Albermarle), magnesium oxide hydroxides, hydrotalcites, dihydrotalcite, magnesium carbonates, magnesium hydroxide carbonates, magnesium calcium carbonates, monobasic, dibasic, or tribasic magnesium phosphate, magnesium hydrogen phosphate, magnesium pyrophosphate, or magnesium borate (®Storflam MGB 11 from Storey).

Among the calcium compounds, preferred stabilizers are calcium borate, calcium pyroborate, calcium carbonate, calcium hydroxide, monobasic, dibasic, tribasic calcium phosphate, calcium hydrogenphosphate and calcium pyrophosphate.

Zinc compounds are preferred stabilizers, e.g. zinc oxide (e.g. Zinkoxid aktiv from Rhein Chemie, Brüggemann K G, zincite, or calamine; standard zinc oxide, G6 zinc white, 2011 zinc oxide, F-80 zinc oxide, Pharma 8 zinc white, Pharma A zinc white, Rotsiegel zinc white, Weissiegel zinc white from Grillo-Werke A G), zinc hydroxide and/or zinc oxide hydrate.

Zinc salts of the oxo acids of the fourth main group are preferred stabilizers (anhydrous zinc carbonate, basic zinc carbonate, zinc hydroxide carbonate, basic zinc carbonate hydrate, (basic) zinc silicate, zinc hexafluorosilicate, zinc hexafluorosilicate hexahydrate, zinc stannate and/or zinc magnesium aluminum hydroxide carbonate).

Zinc salts of the oxo acids of the third main group are preferred stabilizers (zinc borate, e.g. ®Firebrake ZB, ®Firebrake 415 from Borax).

Zinc salts of the oxo acids of the fifth main group are preferred stabilizers (zinc phosphate, zinc hydrogenphosphate, zinc pyrophosphate).

Zinc salts of the oxo acids of the transition metals are preferred stabilizers (zinc chromate(VI) hydroxide (zinc yellow), zinc chromite, zinc molybdate, e.g. ®Kemgard 911 B, zinc permanganate, zinc molybdate magnesium silicate, e.g. Kemgard 911 C from Sherwin-Williams Company, zinc permanganate).

Other zinc salts preferred as stabilizers are those having organic anions, e.g. zinc salts of mono-, di-, oligo-, or polycarboxylic acids (salts of formic acid (zinc formates), of acetic acid (zinc acetates, zinc acetate dihydrate, Galzin), of trifluoroacetic acid (zinc trifluoroacetate hydrate), zinc propionate, zinc butyrate, zinc valerate, zinc caprylate, zinc oleate, zinc stearate (®Liga 101 from Greven Fett-Chemie), of oxalic acid (zinc oxalate), of tartaric acid (zinc tartrate), of citric acid (tribasic zinc citrate dihydrate), of benzoic acid (benzoate), zinc salicylate, of lactic acid (zinc lactate, zinc lactate trihydrate), of acrylic acid, of maleic acid, of succinic acid, of amino acids (glycine), of acidic hydroxy functions (zinc phenolate, etc.), zinc para-phenolsulfonate, zinc para-phenolsulfonate hydrate, zinc acetylacetonate hydrate, zinc tannate, zinc dimethyldithiocarbamate and/or zinc trifluoromethanesulfonate.

Other preferred stabilizers are zinc phosphides, zinc sulfides, zinc selenides, and zinc tellurides.

It is preferable that the average particle diameter of the stabilizer used is from 0.1 to 500 μm, preferably from 1 to 100 μm.

It is preferable that the average particle diameter of the stabilizer used is from 0.1 to 50 μm, preferably from 1 to 10 μm.

Stabilizers with greater average particle diameter give inhomogeneity in the flame-retardant polymer moldings. Those with lower average particle diameter are difficult to prepare industrially.

The binder has been selected in such a way that the agglomerate breaks up on incorporation into the polymer to give separate aggregates and/or primary particles whose average particle sizes are from 0.1 to 500 μm.

The binder binds the aggregates and primary particles to one another, but not so strongly that they cannot be redispersed in a polymer. This means that different binders have to be selected as a function of the process and/or process conditions intended for incorporation of the phosphorus-containing thermally stabilized flame retardant into polymers.

A polyvinylpyrrolidone whose molecular weight is from 5000 to 2 000 000, preferably from 5000 to 200 000, is preferred for use as binder.

Polyvinylpyrrolidone is commercially available with various molecular weights in the form of ®Luviskol (BASF, Germany), e.g. Luviskol(R) K90 molecular weight=from 1 200 000 to 2 000 000, Luviskol(R) K30 molecular weight=from 45 000 to 55 000, Luviskol(R) K17 molecular weight=from 7000 to 11 000.

Preferred binders are polyvinyl alcohol (®Mowiol 8-88, Mowiol 40-88 from Kuraray), polyvinyl butyral (PVB), polyvinylcaprolactam.

Partially hydrolyzed polyvinyl alcohols whose degree of hydrolysis is from 85 to 95 mol % and whose ester value is from 80 to 220 mg of KOH/g and whose viscosity is from 2.5 to 49 mPas at 20° C. in 4% by weight aqueous dispersion are preferred binders.

Other preferred binders are completely hydrolyzed polyvinyl alcohols whose degree of hydrolysis is from 97 to 100 mol % and whose ester value is from 3 to 40 mg KOH/g and whose viscosity is from 2.8 to 60 mPas at 20° C. in 4% by weight aqueous dispersion.

Homopolymers or mixed polymers based on at least one monomer from the group of acrylic acid, amides, cellulose derivatives, epoxides, esters, hydroxyacrylic acid, methacrylic acid, olefins, stearate, urethanes, vinyl acetate, vinyl alcohol derivatives, vinylcaprolactam, vinylpyrrolidone, or a mixture thereof are preferred binders.

Other preferred binders are polycarboxylates.

Polymers based on at least one of the following monomers: polyacrylates, polyhydroxyacrylates, polymaleates, polymethacrylates or a mixture thereof are preferred polycarboxylates.

Examples of suitable polycarboxylates are the sodium salts of polyacrylic acid or of polymethacrylic acid, e.g. those whose relative molecular mass is from 800 to 150 000 (based on acid).

Suitable copolymeric polycarboxylates are in particular those of acrylic acid with methacrylic acid, acrolein, vinyl acetate, and acrylic acid or methacrylic acid with maleic acid. Copolymers of acrylic acid with maleic acid have proven to be particularly suitable where these comprise from 50 to 90% by weight of acrylic acid and from 50 to 10% by weight of maleic acid. The ratio of acrylate units to maleate units in these copolymers can preferably be from 30:1 to about 1:1, particularly preferably from about 10:1 to 2:1. Their relative molecular mass, based on free acids, is generally from 2000 to 200 000, preferably from 10 000 to 120 000, and in particular from 50 000 to 100 000. Examples of commercially available products are ®Sokalan CP 5, PA 30 and CP45 from BASF, ®Alcosperse 175 or 177 from Alco, LMW 45 from NorsoHAAS.

Other preferred binders are biodegradable polymers having more than two different monomers units, for example those in which the monomers present comprise salts of acrylic acid and of maleic acid, or else comprise vinyl alcohol or vinyl alcohol derivatives, or those in which the monomers present comprise salts of acrylic acid and of 2-alkylallylsulfonic acid, or else comprise sugar derivatives.

Copolymers of acrylic acid or methacrylic acid with vinyl ethers, such as vinyl methyl ethers, vinyl ester, ethylene, propylene, and styrene are preferred binders where the content of the acid is at least 50% by weight.

Non-neutralized or only partially neutralized homo- and/or copolymers composed of acrylic acid, of methacrylic acid, of maleic acid, of polyaspartic acid, of sugar carboxylic acid, and/or of other monomers are preferred binders.

Homopolymers of acrylic acid or of methacrylic acid and copolymers thereof with other ethylenically unsaturated monomers are preferred binders, examples being acrolein, dimethylacrylic acid, ethylacrylic acid, vinylacetic acid, allylacetic acid, maleic acid, fumaric acid, itaconic acid, methallylsulfonic acid, vinylsulfonic acid, styrenesulfonic acid, acrylamidomethylpropanesulfonic acid, and also monomers containing phosphoric acid groups, e.g. vinylphosphonic acid, allylphosphonic acid, and acrylamidomethylpropanephosphonic acid, and salts thereof, and also hydroxyethyl(meth)acrylate sulfates, allyl alcohol sulfates, and allyl alcohol phosphates.

Preferred polycarboxylates can be used in the form of their water-soluble salts, particularly in the form of the alkali metal salts, particularly of the sodium salts and/or potassium salts.

Terpolymers are other preferred polycarboxylates. Preferred terpolymers here contain from 60 to 95% by weight, in particular from 70 to 90% by weight of (meth)acrylic acid or (meth)acrylate, particularly preferably acrylic acid or acrylate, and maleic acid or maleate, and also from 5 to 40% by weight, preferably from 10 to 30% by weight, of vinyl alcohol and/or vinyl acetate. Very particular preference is given here to terpolymers in which the ratio by weight of (meth)acrylic acid and, respectively, (meth)acrylate to maleic acid and, respectively, maleate is from 1:1 to 4:1, preferably from 2:1 to 3:1, and in particular from 2.1 to 2.5:1. The amounts and the ratios by weight here are based on the acids.

Terpolymers which contain from 40 to 60% by weight, in particular from 45 to 55% by weight, of (meth)acrylic acid or (meth)acrylate, particularly preferably acrylic acid or acrylate, from 10 to 30% by weight, preferably from 15 to 25% by weight, of methallylsulfonic acid or methallylsulfonate, and, as third monomer, up to 40% by weight, preferably from 20 to 40% by weight, of a carbohydrate are preferred polycarboxylates here. This carbohydrate can by way of example be a mono-, di-, oligo-, or polysaccharide, preference being given to mono-, di-, or oligosaccharides, and particular preference being given to sucrose.

Terpolymers whose relative molecular mass is from 1000 to 200 000, preferably from 200 to 50 000, and in particular from 3000 to 10 000, are preferred polycarboxylates.

Terpolymers which have been either completely or at least partially neutralized, in particular to an extent of more than 50%, based on the carboxy groups present, are preferred polycarboxylates. Particular preference is given here to a completely neutralized terpolymer which is therefore composed of the salts of the monomeric acids, in particular of the sodium or potassium salts of the monomeric acids, and of vinyl alcohol or of a carbohydrate.

Polycarboxylates which can be used either in the form of powder or in the form of an aqueous solution are preferred binders, preference being given to aqueous solutions of strength from 20 to 55% by weight.

Other preferred binders are polymers based on at least one of the following monomers or mixtures thereof: maleic acid, maleic anhydride, methylstyrene, styrene, styrenesulfonic acid.

Homo- and copolymers of polystyrenesulfonic acid are particularly preferred. Polystyrenesulfonic acid homopolymers whose molecular weights are from 10 000 to 1 200 000 are preferred.

Polystyrenesulfonic acid homopolymers in the form of aqueous solutions with from 20 to 50% by weight of active substance are preferred.

Polystyrenesulfonic acid homopolymers in the form of aqueous solutions with viscosities of from 5 to 1600 mPa*s are preferred.

Polystyrenesulfonic acid homopolymers in the form of aqueous solutions with pH values of from 7 to 11 are preferred.

Polystyrenesulfonic acid-maleic anhydride copolymers with molecular weights of from 10 000 to 1 200 000 are preferred.

Polystyrenesulfonic acid copolymers having styrenesulfonic acid:maleic acid molar ratios of from 1:1 to 4:1 are preferred.

Water Glass

Preference is given to aqueous alkali metal silicate solutions whose silicon dioxide/sodium oxide molar ratio is from 1:2 to 4:1. The active substance content of the solutions is particularly preferably from 5 to 50% by weight.

Vinyl Acetate Polymers

Preference is given to polymers based on at least one of the following monomers or a mixture thereof: vinyl acetate, 2-ethylhexyl acrylate, acrolein, acrylic ester, acrylic acid, crotonic acid, dibutyl maleate, ethylene, methyl methacrylate, n-butyl acrylate, N-hydroxymethylacrylamide, N-vinylpyrrolidone, styrene, tert-butyl chloride, vinyl chloride, vinyl laurate, vinyl propionate. Preferred representative monomers are ™Airflex EP3360, EP16, EAF375 from Air Products, and ™Mowilith LDM from Kuraray.

Acrylates

Preference is given to polymers based on at least one of the following monomers or a mixture thereof: methacrylate, 1,2-butadiene, 1,3-butadiene, 2-ethylhexyl acrylate, acrylamide, acrylonitrile, acrylic acid, ethyl acrylate, ethyl methacrylate, isobutyl acrylate, isobutyl methacrylate, lauryl acrylate, and/or methyl methacrylate, methacrylamide, methacrylonitrile, methacrylic acid, n-butyl acrylate, n-butyl methacrylate, n-hexyl acrylate, n-hexyl methacrylate, n-propyl acrylate, sec-butyl acrylate, styrene, tert-butyl acrylate, tert-butyl methacrylate, vinyl acetate, vinyl chloride, vinylidene chloride, vinyl propionate. Preferred representative monomers are ®Acronal 18D from BASF.

Polylactic Acid

Further preference is given to homopolymers of lactic acid (polylactides) or poly(lactide-caprolactone) copolymers, poly(lactide-glycolide) copolymers, poly(lactide-caprolactone-glycolide) terpolymers, poly(lactide-glycolide-ethylene glycol) terpolymers. The preferred molecular weights are from 5000 to 150 000.

Starch and Cellulose

It is also possible to use soluble starch preparations and starch products other than the abovementioned, e.g. degraded starch, aldehyde starches, etc., carboxyalkylcellulose (Na salt), hydroxyethylcellulose, hydroxypropylcellulose, alkylcellulose, alkylhydroxyethylcellulose (alkyl preferably being methyl), and sodium carboxymethylcellulose.

Preferred Binders are Film-Forming Binders.

Other preferred binders are homopolymers based on vinyl acetate, copolymers based on vinyl acetate, ethylene, and vinyl chloride, copolymers based on vinyl acetate and on a vinyl ester of a long-chain, branched carboxylic acid, copolymers based on vinyl acetate and di-n-butyl maleate, copolymers based on vinyl acetate and acrylic ester, copolymers based on styrene and acrylic ester, copolymers based on acrylate/vinyltoluene, copolymers based on acrylate/styrene, copolymers based on acrylate/vinyl, and/or self-crosslinking polyurethane dispersions.

Processes for Preparation of the Agglomerate

The invention also provides a process for preparation of phosphorus-containing thermally stabilized flame retardant agglomerates, which comprises agglomerating aggregates and/or primary particles composed of

a) a phosphinic salt of the formula (I) and/or composed of a diphosphinic salt of the formula (II), and/or composed of polymers thereof, and

b) a stabilizer, and

c) optionally at least one synergist,

in the presence d) of a binder, and

e) optionally of a granulation aid,

and optionally carrying out an aging phase,

and optionally removing the granulation aid,

and optionally isolating agglomerates of suitable size,

and optionally treating agglomerates of unsuitable size and returning them to the agglomerating process.

Components a-e) can be mixed and agglomerated in one operation, or in various separate operations in any desired sequence.

It is preferable that the specific energy input during the agglomerating process is from 0.0014 to 1 kWh/kg, particularly preferably from 0.05 to 0.5 kWh/kg.

The agglomerating process preferably takes place at a pressure of from 10 to 100 000 000 Pa, for a period of from 0.01 to 1000 h, and at a temperature of from −20 to +500° C., particularly preferably from 50 to 350° C.

It is preferable that the aging phase takes place at a pressure of from 10 to 100 000 000 Pa, over a period of from 0.01 to 1000 h, and at a temperature of from −20 to +500° C., particularly preferably from 50 to 350° C.

The granulation aid is removed in one stage or in two or more stages, preferably at a pressure of from 10 to 100 000 000 Pa, over a period of from 0.01 to 1000 h, and at a temperature of from −20 to +500° C., particularly preferably from 50 to 350° C.

The granulation aid is preferably at least one member of the group of alcohols, esters, ketones, hydrocarbons, water.

It is preferable to add from 5 to 50% by weight of granulation aid, based on dry solid, particularly preferably from 10 to 40% by weight.

The agglomerating process preferably takes place in mixers of the following type: double-cone mixers from TELSCHIG Verfahrenstechnik GmbH, twin-shaft paddle mixers from Eirich, Flexomix mixers from Schugi, fluidized-bed mixers from TELSCHIG Verfahrenstechnik GmbH, fluid mixers from Thyssen Henschel Industrietechnik GmbH, free-fall mixers from TELSCHIG Verfahrenstechnik GmbH (WPA6) or Hauf, intensive mixers—mixers from Eirich (e.g. R02, R 12, DE 18, Evactherm), conical-screw mixers from Nauta, in which the mix is circulated by a screw, using the Archimedes principle, cooling mixers from Papenmeier or Thyssen Henschel Industrietechnik GmbH, air-jet mixers from TELSCHIG Verfahrenstechnik GmbH, plowshare mixers from Lödige (M5 or M20), TELSCHIG Verfahrenstechnik GmbH, or Minox (PSM 10 to 10 000), planetary mixers from Hobart, annular-gap and annular-layer mixers from Lödige, (e.g. CB30, CB Konti-Mischer), Niro (HEC), Drais/Mannheim (e.g. K-TTE4), spray mixers from TELSCHIG Verfahrenstechnik GmbH, tumbling or container mixers, e.g. from Thyssen Henschel Industrietechnik GmbH, zig-zag mixers from Niro.

The inventive process can be carried out either in high-intensity mixers or in low-speed mixers.

High-intensity mixers can be operated at low speed in a first stage of the process, and if low-speed mixers are used, the energy input needed for a second stage of the process can be supplied via additional assemblies, such as knife rings.

Examples of high-speed mixers are the Lödige™ CB 30 Recycler, the Schugi™ granulator, the Schugi™ Flexomix, the Eirich™ R mixer, or the Drais™ K-TTP 80.

Examples of low-speed mixer-granulators are the Drais™ K-T 160 and the Lödige™ KM 300. The latter is often termed the Lödige plowshare mixer. Preferred peripheral velocities of the mixing units in suitable plowshare mixers are from 2 to 7 m/s, whereas the peripheral velocities of other suitable mixers are from 3 to 50 m/s, in particular from 5 to 20 m/s.

Dish granulators are also suitable for the invention.

It is preferable that the granulation aid is removed via drying. It is preferable that drying temperatures are from 50 to 350° C.

Convective driers with dessicant flowing over the product to be dried are preferred, e.g. chamber driers, duct driers, belt driers, mixing driers (disk driers, drum driers, paddle driers).

Convective driers with dessicant flowing through the product to be dried are preferred, e.g. kilns (roaster driers), chamber tray driers, paddle driers (centrifugal driers), mill driers.

Convective driers with dessicant flowing around the product to be dried are preferred, e.g. flotation driers (pneumatic driers, fluidized-bed driers, cyclone driers, spray driers), spherical-bed driers (spherical-substrate driers).

Contact driers are preferred, e.g. drying cabinets, thin-film driers, (spiral-tube pneumatic driers, cylinder driers, screw evaporators), mixer-driers (multitube revolving driers, disk-drum driers, paddle driers).

Vacuum driers are preferred, e.g. vacuum drying cabinets, vacuum cylinder driers, vacuum paddle driers.

The temperature of gas inlet to the driers is from 50 to 320° C., preferably from 60 to 250° C., and the output temperature is preferably from 25 to 180° C.

Agglomerates of suitable size are extracted via the classification methods of the prior art (sieving, sifting, etc.).

The preferred method of treatment of agglomerates of unsuitable grain size is milling.

The invention also provides a flame-retardant polymer molding composition which comprises the inventive phosphorus-containing thermally stabilized flame retardant agglomerates.

The flame-retardant polymer molding composition preferably comprises from 1 to 50% by weight of phosphorus-containing thermally stabilized flame retardant agglomerates, from 1 to 99% by weight of polymer or a mixture of these from 0 to 60% by weight of additives from 0 to 60% by weight of filler and/or reinforcing materials.

The flame-retardant polymer molding composition particularly preferably comprises

from 5 to 30% by weight of phosphorus-containing thermally stabilized flame retardant agglomerates,

from 5 to 90% by weight of polymer or a mixture of these

from 5 to 40% by weight of additives

from 5 to 40% by weight of filler and/or reinforcing materials.

The polymer is preferably a thermoplastic or thermoset polymer.

The thermoset polymer is preferably formaldehyde polymers, epoxy polymers, melamine-phenolic resin polymers, and/or polyurethanes.

The thermoplastic polymers are preferably HI (high-impact) polystyrene, polyphenylene ethers, polyamides, polyesters, polycarbonates, and blends or polyblends of the type represented by ABS (acrylonitrile-butadiene-styrene) or PC/ABS (polycarbonate/acrylonitrile-butadiene-styrene).

The thermoplastic polymers are in particular polyamide, polyester, or ABS.

The invention also provides polymer moldings, polymer films, polymer filaments, and polymer fibers which comprise the inventive phosphorus-containing thermally stabilized flame retardant agglomerates and/or which comprise the inventive flame-retardant polymer molding compositions.

The polymer moldings, polymer films, polymer filaments, and polymer fibers preferably comprise

from 1 to 50% by weight of phosphorus-containing thermally stabilized flame retardant agglomerates,

from 1 to 99% by weight of polymer or a mixture of these

from 0 to 60% by weight of additives

from 0 to 60% by weight of filler and/or reinforcing materials.

The polymer moldings, polymer films, polymer filaments, and polymer fibers particularly preferably comprise

from 5 to 30% by weight of phosphorus-containing thermally stabilized flame retardant agglomerates

from 5 to 90% by weight of polymer or a mixture of these

from 5 to 40% by weight of additives

from 5 to 40% by weight of filler and/or reinforcing materials.

Determination of Grain Size Distribution Via Sieve Analysis

The inserts with appropriate sieves are used in a Retsch sieving machine. The mesh width of the sieves here decreases from the top to the bottom. 50 g of the powder to be tested are applied to the widest sieve. The vibratory movement of the sieving machine causes the pulverulent material to move through the various sieves. The residues on the sieves are weighed, and a calculation is made to relate these to the weight of material used. From the values it is possible to calculate d₅₀ (average particle diameter) and d₉₀ values.

Heat Treatment and Determination of Color Values

The granulated material to be tested is heat-treated at 280° C. in a muffle furnace for 15 min. A ®Luci 100 colorimeter from Dr. Lange is then used to determine whiteness. The color values stated are the Hunter system (CIE-LAB system) values. L color values extend from 0 (black) to 100 (white), a color values from −a (green) to +a (red), and b color values from −b (blue) to +b (yellow). The more negative the b value, the more intensely blue is the material tested.

Abrasion Value

The specimen is sieved using a VE 1000 vibrator from Retsch for 2 min at 2 mm amplitude without interruption by way of a 0.2 mm sieve. The amount of specimen is to be selected in such a way that at least 50 g of material coarser than 200 μm are present after the sieving process. 50 g of the fraction coarser than 200 μm are weighed with 0.1 g accuracy into the base of a sieve set. 18 steel spheres (diameter 10 mm, total weight 72.8 g) are added, and then the sieving machine is started for 5 min at 2 mm amplitude without interruption. After the milling process, the steel spheres are removed and the entire specimen is applied to a 200 μm sieve and again sieved at 2 mm amplitude without interruption for 2 min. The percentage proportion of material finer than 200 μm gives the abrasion value.

### EXAMPLE 1

### Comparison

3.920 g of aluminum phosphinate are used as initial charge in a 20 l plowshare mixer from Lödige. 0.080 kg of PVA dissolved in 1.333 kg of water are applied by spraying within a period of 15 min, at room temperature. This takes place with continuous mixing at a specified rotation rate (about 230 rpm) and with knife heads in operation. Mixing is then continued for 5 min. The product is dried in a laboratory drier from Retsch for 60 min at an air input temperature of 120° C., then sieved through two sieves (200 μm and 1700 μm). Good product is the fraction of grain size greater than 200 μm and below 1700 μm.

### EXAMPLE 2

An agglomerate is prepared as in example 1 from 3.920 g of a mixture composed of about 94.9% of aluminum phosphinate and about 5.1% of stabilizer, via application by spraying of 0.080 kg of PVA dissolved in 1.333 kg of water, and mixing, drying, and sieving.

### EXAMPLE 3

An agglomerate is prepared as in example 1 from 3.980 g of a mixture composed of about 98.5% of aluminum phosphinate and about 1% of stabilizer, via application by spraying of 0.020 kg of PVA dissolved in 2.154 kg of water, and mixing, drying, and sieving.

### EXAMPLE 4

A mixture is prepared as in example 1 from 3.400 g of aluminum phosphinate and 0.400 g of stabilizer. 0.200 kg of PVA dissolved in 1.714 kg of water are then applied by spraying, and an agglomerate is prepared via mixing, drying, and sieving.

### EXAMPLE 5

An agglomerate is prepared as in example 1 from 3.800 g of a mixture composed of about 98.9% of aluminum phosphinate and about 1.1% of stabilizer, via application by spraying of 0.200 kg of PVA dissolved in 1.000 kg of water, and mixing, drying, and sieving.

### EXAMPLE 6

### Comparison

1470 kg of a mixture composed of 67% by weight of aluminum phosphinate and 33% by weight of synergist is mixed with a solution of 30 kg of PVA in 448 kg of water in a mixer from Schugi (Flexomix 160) with downstream batch fluidized bed for a period of one hour and after-dried to the desired moisture content (air input temperature 150° C.). The product is isolated by sieving, using an Allgaier sieve, via an 800 μm sieve and by way of a 200 μm sieve.

### EXAMPLE 7

An agglomerate is prepared as in example 6 from 1470 kg of a mixture composed of 63.2% by weight of aluminum phosphinate, 31.6% by weight of synergist, and 5.1% of stabilizer, and a solution of 30 kg of PVA in 448 kg of water, via mixing, drying, and sieving.

### EXAMPLE 8

A mixture is prepared as in example 1 from 2.820 kg of aluminum phosphinate, 0.960 kg of synergist, and 0.200 kg of stabilizer. 1.690 kg of water are then first applied by spraying, followed by 0.044 kg of PCA, and an agglomerate is prepared via mixing, drying, and sieving.

### EXAMPLE 9

0.396 kg of a mixture composed of about 49.5% by weight of aluminum phosphinate, about 49.5% by weight of synergist, and about 1% of stabilizer is used as initial charge on a dish granulator of diameter about 70 cm and is granulated via spray application first of 0.266 kg of water and then of 0.010 kg of PAS. The rotation rate of the dish is 70 rpm, the angle of incidence is from 70 to 75 degrees, and the temperature is room temperature. The product is dried in a Retsch laboratory drier for 60 min using an air input temperature of 120° C., then sieved via two sieves (300 μm and 3000 μm). Good product is the fraction whose grain size is from 300 μm to 3000 μm.

### EXAMPLE 10

An agglomerate is prepared as in example 9 from 0.396 kg of a mixture composed of about 22.2% by weight of aluminum phosphinate, about 67.7% by weight of synergist, and about 10.1% of stabilizer, and a solution of 0.008 kg of EVA dissolved in 0.266 kg of water, via spray application, mixing, drying, and sieving.

Chemicals Used

ALP Aluminum phosphinate, ™Exolit OP1230 from Clariant GmbH
SYN ™Melapur 200-70, Ciba SC
STB 1 ™Firebrake 500, Borax
STB 2 ™Zinkoxid aktiv, Rheinchemie
STB 3 Magnesium borate, ™Storflam MGB 11, Storey
STB 4 Boron phosphate, ™Budit 1304, Budenheim
PVA Polyvinyl alcohol, ™Mowiol 3-85, Kuraray
PCA Acrylic acid-maleic acid copolymer, sodium salt, MW=50 000, ®Sokalan CP 5, 45% soln., BASF
PAS Polyacrylic acid, sodium salt, MW=30 000, 40% aq. soln., Sigma-Aldrich

EVA Aqueous ethylene-acrylate-vinyl acetate terpolymer dispersion, about 51% by weight, ™Airflex EAF375, Air Products

TABLE 1
Properties of phosphorus-containing thermally stabilized
flame retardant agglomerates

| | | Examples | | | | | | | | | |
|---|---|---|---|---|---|---|---|---|---|---|---|
| | | 1 | | | | | 6 | | | | |
| | | comp. | 2 | 3 | 4 | 5 | comp. | 7 | 8 | 9 | 10 |
| ALP | [% by wt.] | 98 | 93 | 98.5 | 85 | 94 | 66 | 62 | 70.5 | 49 | 22 |
| SYN | [% by wt.] | | | | | | 32 | 31 | 24 | 49 | 67 |
| STB 1 | [% by wt.] | 0 | 5 | 1 | | | 0 | 5 | | | |
| STB 2 | | | | | 10 | 1 | | | 5 | | |
| STB 3 | | | | | | | | | | 1 | |
| STB 4 | | | | | | | | | | | 10 |
| PVA | [% by wt.] | 2 | 2 | 0.5 | 5 | 5 | 2 | 2 | | | |
| PCA | [% by wt.] | | | | | | | | 0.5 | | |
| PAS | [% by wt.] | | | | | | | | | 1 | |
| EVA | [% by wt.] | | | | | | | | | | 1 |
| Whiteness | L value | 70.93 | 91.5 | 92.1 | 93.9 | 86.2 | 74.4 | 91.54 | 92.08 | 90.23 | 96.1 |
| Whiteness | a value | 4.74 | −0.2 | 0.2 | 0.3 | 1.5 | 3.26 | −0.24 | 0.16 | 0.28 | 0.11 |
| Whiteness | b value | 12.97 | 5.2 | 2.7 | 1.6 | 7.2 | 10.57 | 5.15 | 2.72 | 2.99 | 1.20 |
| Residual | [% by wt.] | 0.2 | 0.2 | 0.4 | 0.5 | 0.3 | 0.3 | 0.3 | 0.7 | 0.5 | 0.6 |
| moisture | | | | | | | | | | | |
| level | | | | | | | | | | | |
| Abrasion | [%] | 77 | 71 | 74 | 87 | 76 | 42 | 38 | 65 | 57 | 64 |
| value | | | | | | | | | | | |

Surprisingly, it has been found that selection of inventive stabilizer can substantially inhibit discoloration on heating of the phosphorus-containing thermally stabilized flame retardant agglomerates.

This is first apparent for synergist-free agglomerates when the color values of comparative example 1 are compared with those of inventive examples 2 to 5.

In the comparative example, L, a, and b color values lie outside the inventive ranges (L: from 88 to 99.9, a: from −2 to +2, b: from −2 to +8), but they lie within those ranges in the inventive examples.

The surprising stabilization effect in synergist-containing agglomerates is apparent via comparison of comparative example 6 with inventive example 7.

In the comparative example, L, a, and b color values lie outside the inventive ranges

(L: from 88 to 99.9, a: from −2 to +2, b: from −2 to +8), but they lie within those ranges in the inventive examples.

It is moreover surprising that the stabilizer system is also active with various binders, as shown by examples 7, 8, 9, and 10.

In the inventive examples, L, a, and b color values are within the inventive ranges

(L: from 88 to 99.9, a: from −2 to +2, b: from −2 to +8).

TABLE 2
Amounts used for preparation of phosphorus-containing
thermally stabilized flame retardant agglomerates

| | | Example | | | | | | | | | |
|---|---|---|---|---|---|---|---|---|---|---|---|
| | | 1 | | | | | 6 | | | | |
| | | comp. | 2 | 3 | 4 | 5 | comp. | 7 | 8 | 9 | 10 |
| Mixture of | [kg] | — | 3.920 | 3.980 | | 3.800 | | | | | |
| ALP and STB | | | | | | | | | | | |
| Mixture of | | | | | | | 1470 | | | | |
| ALP and | | | | | | | | | | | |
| SYN | | | | | | | | | | | |
| Mixture of | | | | | | | | 1470 | | 0.396 | 0.396 |
| ALP, SYN | | | | | | | | | | | |
| and STB | | | | | | | | | | | |
| ALP | [kg] | 3.920 | | | 3.400 | | | | 2.820 | | |
| SYN | | | | | | | | | 0.960 | | |
| STB | | | | | 0.400 | | | | 0.200 | | |
| Water | [kg] | 1.333 | 1.333 | 2.154 | 1.714 | 1.000 | 448 | 448 | 1.690 | 0.266 | 0.266 |
| PVA | [kg] | 0.080 | 0.080 | 0.020 | 0.200 | 0.200 | 30 | 30 | | | |
| PCA | [kg] | | | | | | | | 0.044 | | |
| PAS | [kg] | | | | | | | | | 0.010 | |
| EVA | [kg] | | | | | | | | | | 0.008 |

1. A process for producing thermally stabilized phosphorus-containing flame retardant agglomerates comprising the step of adding at least one stabilizer and at least one binder to the phosphorus-containing flame retardant to the agglomerates.

2. The method as claimed in claim 1, wherein the at least one stabilizer is a compound of the elements of the second main and transition group and of the third main group.

3. The use as claimed in claim 1, wherein the at least one stabilizer is a compound of the elements boron, calcium, magnesium, or zinc.

4. The method as claimed in claim 1, wherein the at least stabilizer is boron phosphate.

5. The method as claimed in claim 1, wherein the at least one stabilizer is calcium borate, calcium pyroborate, calcium carbonate, calcium hydroxide, calcium phosphates, calcium hydrogenphosphates, calcium pyrophosphate, or mixtures thereof.

6. The method as claimed in claim 1, wherein the at least one stabilizer is magnesium oxide, magnesium hydroxide, magnesium oxide hydroxides, hydrotalcites, dihydrotalcite, magnesium carbonates, magnesium hydroxide carbonates, magnesium calcium carbonates, magnesium phosphates, magnesium hydrogenphosphates, magnesium pyrophosphate, magnesium borate or mixtures thereof.

7. The method as claimed in claim 1, wherein the at least one stabilizer is zinc oxide, zinc hydroxide, zinc oxide hydrate; zinc carbonates, zinc hydroxide carbonate, zinc carbonate hydrate, zinc silicate, zinc hexafluorosilicate, zinc hexafluorosilicate hexahydrate, zinc stannate, zinc magnesium aluminum hydroxide carbonate; zinc borate, zinc phosphate, zinc hydrogenphosphate, zinc pyrophosphate; zinc chromate(VI) hydroxide, zinc chromite, zinc molybdate, zinc permanganate, zinc molybdate magnesium silicate; zinc formates, zinc acetates, zinc trifluoroacetates, zinc propionate, zinc butyrate, zinc valerate, zinc caprylate, zinc oleate, zinc stearate, zinc oxalate, zinc tartrate, zinc citrate, zinc nenzoate, zinc salicylate, zinc lactate, zinc phenolate, zinc phenolsulfonate, zinc acetylacetonate, zinc tannate, zinc dimethyldithiocarbamate, zinc trifluoromethanesulfonate; zinc phosphides, zinc sulfides, zinc selenides, or zinc tellurides.

8. The method as claimed in claim 1, wherein the at least one stabilizer is boron phosphate, calcium pyrophosphate, magnesium pyrophosphate, magnesium borate, zinc oxide, zinc hydroxide, zinc borate, zinc stearate, zinc pyrophosphate and mixture thereof.

9. The method as claimed in claim 1, wherein the phosphorus-containing flame retardant agglomerates are compositions comprising
a) from 6 to 99.89% by weight of aggregates and/or primary particles composed of a phosphinic salt of the formula (I) a diphosphinic salt of the formula (II), a polymer of the phosphinic salt of the formula (I), a polymer of the diphosphinic salt of the formula (II) or mixtures thereof, 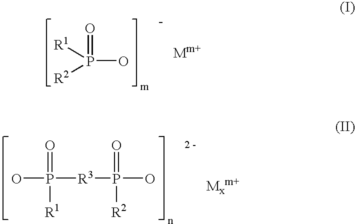
whrein
R¹ and R² are identical or different and are C1-C6-alkyl, linear or branched, or aryl;
R³ is C₁-C₁₀-alkylene, linear or branched, C₆-C₁₀-arylene, -alkylarylene, or -arylalkylene;
M is Mg, Ca, Al, Zn, Sb, Sn, Ge, Zn, Ti, Fe, Zr, Ce, Bi, Sr, Mn, Li, Na, K, or a protonated nitrogen base;
m is from 1 to 4; n is from 1 to 4; x is from 1 to 4, and
b) from 0.01 to 20% by weight of a binder,
c) from 0.1 to 20% by weight of the at least one stabilizer.

10. The method as claimed in claim 9, wherein the phosphorus-containing flame retardant agglomerates are compositions comprising
a) from 6 to 99.89% by weight the aggregates and/or primary particles, at least one synergist, and
b) from 0.01 to 20% by weight of the binder,
c) from 1 to 20% of the at least one stabilizer.

11. The method as claimed in claim 1, wherein the L color values of the phosphorus-containing flame retardant agglomerates after heat treatment are from 81 to 99.9.

12. The method as claimed in claim 1, wherein the a color values of the phosphorus-containing flame retardant agglomerates are from −2 to +2.

13. The method as claimed in claim 1, wherein the b color values of the phosphorus-containing flame retardant agglomerates are from −2 to +8.

14. The method as claimed in claim 1, wherein the phosphorus-containing flame retardant agglomerates further comprise at least one synergist having a compound selected from the group consisting of nitrogen compounds, phosphorus compounds and phosphorus-nitrogen compounds.

15. The method as claimed in claim 14, wherein the at least one synergist is melamine pyrophosphate, melamine polyphosphate, melam polyphosphate, melem polyphosphate, melon polyphosphate, melamine cyanurate, melamine, melam, melem, melon and mixtures thereof.

16. The method as claimed in claim 1, wherein the at least one binder is a hompolymer or mixed polymers based on at least one monomer selected from the group consisting of 1,2-butadiene, 1,3-butadiene, 2-ethylhexyl acrylate, degraded starch, acrolein, acrylamide, acrylamidomethylpropanephosphonic acid, hydroxyethyl(meth)acrylate sulfates, acrylamidomethylpropanesulfonic acid, acrylic ester, acrylonitrile, acrylic acid, aldehyde starches, alkylcellulose, alkylhydroxyethylcellulose, and alkyl is preferably methyl, allyl alcohol phosphates, allyl alcohol sulfates, allylacetic acid, allylphosphonic acid, amides, aspartic acid, caprolactam, carboxyalkylcellulose (Na-salt), crotonic acid, di- or oligosaccharides, dibutyl maleate, dimethylacrylic acid, epoxides, esters, ethyl acrylate, ethylacrylic acid, ethylene, ethylene glycol, ethylhexyl acrylate, ethyl methacrylate, fumaric acid, hydroxyacrylic acid, hydroxyethylcellulose, hydroxypropylcellulose, isobutyl acrylate, isobutyl methacrylate, itaconic acid, lauryl acrylate, maleic acid, maleic anhydride, methallylsulfonic acid, methacrylamide, methacrylate, methacrylonitrile, methacrylic acid, methyl methacrylate, methylstyrene, lactic acid, monosodium carboxymethylcellulose, n-butyl acrylate, n-butyl methacrylate, n-hexyl acrylate, n-hexyl methacrylate, N-hydroxymethyl acrylamide, n-propylacrylate, N-vinylpyrrolidone, olefins, polyvinyl butyral, polyvinylcaprolactam, propylene, sec-butyl acrylate, stearates, styrene, styrenesulfonic acid, tert-butyl acrylate, tert-butyl chloride, tert-butyl methacrylate, urethanes, vinyl acetate, vinyl alcohol derivatives, vinylcaprolactam, vinyl chloride, vinylacetic acid, vinyl esters, vinyl ethers, vinylidene chloride, vinyl laurate, vinyl methyl ethers, vinylphosphonic acid, vinyl propionate, vinylpyrrolidone, vinylsulfonic acid, sugar carboxylic acid, sand a mixture thereof.

17. The method as claimed in claim 1, wherein the at least one binder is polyvinyl acetate, polyvinyl alcohol, polyvinylpyrrolidone, polycarboxylate, acrylic acid-maleic acid copolymer, polystyrenesulfonic acid, polystyrenesulfonic acid-maleic anhydride copolymer, water glass, vinyl acetate polymer, polyacrylate/polyacrylic acid, polylactic acid, starch, and cellulose derivatives.

18. A polymer article comprising thermally stabilized phosphorous-containing flame retardant agglomerates as claimed in claim 24, wherein the polymer article is selected from the group consisting of polymer molding compositions polymer moldings, polymer films, polymer filaments, and polymer fibers.

19. The polymer article as claimed in claim 18, wherein the flame-retardant polymer article comprises
from 1 to 50% by weight of phosphorus-containing the thermally stabilized flame retardant agglomerates,
from 1 to 99% by weight of polymer or a mixture of polymers,
from 0 to 60% by weight of additives,
from 0 to 60% by weight of filler of reinforcing materials, or a mixture thereof.

20. The polymer article as claimed in claim 18, comprising from 1 to 50% by weight of the phosphorus-containing thermally stabilized flame retardant agglomerates,
from 1 to 99% by weight of polymer or a mixture of polymers,
from 0 to 60% by weight of additives,
from 0 to 60% by weight of fillers, reinforcing materials or a mixture thereof.

21. The method as claimed in claim 1, wherein the L color values of the phosphorus-containing flame retardant agglomerates after heat treatment are from from 85 to 98.

22. The method as claimed in claim 1, wherein the a color values of the phosphorus-containing flame retardant agglomerates are from −1 to +1.5.

23. The method as claimed in claim 1, wherein the b color values of the phosphorus-containing flame retardant agglomerates are from −1 to +7.

24. Thermally stabilized phosphorous-containing flame retardant agglomerates made in accordance with the process of claim 1.
